(19) United States
(12) Patent Application Publication
(10) Pub. No.: US 2026/0370789 A1
(43) Pub. Date: Nov. 19, 2026

(54) THREE-DIMENSIONAL VISUALIZATION USING SINGLE SENSOR AND SINGLE LENS APPARATUS

(71) Applicant: Lux Aeterna Inc, Westlake Village, CA (US)

(72) Inventor: Laurent Blanquart, Westlake Village, CA (US)

(73) Assignee: Lux Aeterna Inc, Westlake Village, CA (US)

(21) Appl. No.: 19/209,371

(22) Filed: May 15, 2025

(51) Int. Cl. H04N 13/207; H04N 13/257; H04N 25/11

(52) U.S. Cl. CPC H04N 13/207; H04N 13/257; H04N 25/11

(57) ABSTRACT

Systems and methods for outputting three-dimensional visualization renderings based upon imaging data output by a single image sensor. A system includes an aperture stop comprising: a first aperture comprising a first aperture filter, wherein the first aperture filter is a first channel filter; and a second aperture comprising a second aperture filter, wherein the second aperture filter is a second channel filter. The system includes an image sensor comprising a pixel array comprising a plurality of pixels and a plurality of pixel filters, wherein the plurality of pixel filters forms a filter array comprising: a first plurality of pixel filters comprising the first channel filter; and a second plurality of pixel filters comprising the second channel filter.

### TECHNICAL FIELD

This disclosure relates generally to imaging, and more specifically but not entirely to three-dimensional stereoscopic imaging and producing 3D stereoscopic images or videos. The disclosure is directed to systems and methods for digital imaging, and more specifically to systems and methods for three-dimensional (3D) visualization of a scene with a single image sensor, and a lens coupled together with a set of filters allowing for simultaneous capture of two stereo images within the same frame.

### BACKGROUND

3D digital imaging is beneficial in many applications to provide improved depth perception. The 3D visualization provides a more realistic perception that aids in assessing a scene and then performing tasks based upon those assessments.

Conventional 3D digital imaging systems utilize binocular vision cameras that utilize two optical systems. These conventional systems are known to face numerous issues and may be incompatible with systems utilized in a space-constrained environment. Many conventional 3D digital imaging systems require more space when compared to conventional non-3D cameras, because the conventional 3D systems include at least two image sensors and two lens assemblies. Additionally, manufacturing conventional 3D imaging systems is a challenge because stereoscopic cameras must be calibrated with respect to each other, including with respect to magnification, depth of focus, distortion, position, orientation, and so forth. Additionally, optical crosstalk between two cameras may need to be eliminated, and special attention may be paid to mechanical separation between left and right channels. Additionally, the cost of conventional 3D digital imaging systems is high, and may be significantly more than twice the price of regular non-3D cameras, even though the material is doubled. This is due to the extra manufacturing costs related to the alignment and adjustment.

What is needed are systems, methods, and devices for 3D digital imaging that address the issues outlined above. In view of the foregoing, described herein are systems, methods, and devices for 3D digital imaging that utilize a single sensor and a single lens assembly.

### BRIEF DESCRIPTIONS OF THE DRAWINGS

Non-limiting and non-exhaustive implementations of the disclosure are described with reference to the following figures, wherein like reference numerals refer to like parts throughout the various views unless otherwise specified. Advantages of the disclosure will become better understood with regard to the following description and accompanying drawings where:

FIG. 1 is a schematic block diagram of a system for outputting a three-dimensional visualization rendering of a scene based upon digital imaging data output by a single image sensor;

FIG. 2A is a schematic illustration of a binocular imaging system comprising two camera systems, wherein an object is placed at a convergence distance and object images are disposed at a same location on both left and right image sensors;

FIG. 2B is a schematic illustration of a binocular imaging system comprising two camera systems, wherein an object is placed beyond a convergence point such that object images are at different locations on left and right image sensors;

FIG. 2C is a schematic illustration of a binocular imaging system comprising two camera systems, wherein an object is placed between a convergence point and the cameras such that object images are at a different location on left and right image sensors;

FIG. 3 is a schematic illustration of a conventional non-3D single image sensor and single lens assembly disposed within a confined space;

FIG. 4 is a schematic illustration of a conventional binocular vision camera utilizing two optical systems within a confined space;

FIG. 5 is a schematic illustration of a conventional binocular vision camera utilizing two optical systems disposed within a confined space;

FIG. 6A is a schematic illustration of a conventional f-stop element of a lens;

FIG. 6B is a schematic illustration of an image projection of an object placed at an ideal focus distance;

FIG. 6C is a schematic illustration of an image projection of an object placed beyond an ideal focus distance;

FIG. 6D is a schematic illustration of an image projection of an object placed in between an ideal focus distance and a camera;

FIG. 7A is a schematic illustration of a modified f-stop element of a lens assembly comprising a second aperture and a first aperture;

FIG. 7B is a schematic illustration of an image projection of an object placed at an ideal focus distance from the camera with the modified f-stop element described in connection with FIG. 7A;

FIG. 7C is a schematic illustration of an image projection of an object placed beyond an ideal focus distance from the camera with the modified f-stop element described in connection with FIG. 7A;

FIG. 7D is a schematic illustration of an image projection of an object placed in between an ideal focus distance and the camera with the modified f-stop element described in connection with FIG. 7A;

FIG. 8 is a schematic illustration of an optical assembly for capturing 3D imaging data based upon pixel accumulation data output by a single image sensor, wherein the image sensor comprises a row-based channel filter array;

FIG. 9 is a schematic illustration of an optical assembly for capturing 3D imaging data based upon pixel accumulation data output by a single image sensor, wherein the image sensor comprises a row-based channel filter array combined with a color filter array;

FIG. 10 is a schematic illustration of an optical assembly for capturing 3D imaging data based upon pixel accumulation data output by a single image sensor, wherein the image sensor comprises a column-based channel filter array;

FIG. 11 is a schematic illustration of an optical assembly for capturing 3D imaging data based upon pixel accumulation data output by a single image sensor, wherein the image sensor comprises a column-based channel filter array combined with a color filter array;

FIG. 12 is a schematic illustration of an optical assembly for capturing 3D imaging data based upon pixel accumulation data output by a single image sensor, wherein the image sensor comprises a checkerboard-based channel filter array;

FIG. 13 is a schematic illustration of an optical assembly for capturing 3D imaging data based upon pixel accumulation data output by a single image sensor, wherein the image sensor comprises a checkerboard-based channel filter array combined with a color filter array;

FIG. 14 is a schematic illustration of an optical assembly for capturing 3D and 2D imaging data based upon pixel accumulation data output by a single image sensor, wherein the image sensor comprises a filter array with the four 45 degree separation polarization channels;

FIG. 15 is a schematic illustration of an optical assembly for capturing 3D and 2D imaging data based upon pixel accumulation data output by a single image sensor, wherein the image sensor comprises a filter array with the four 45 degree separation polarization channels combined with a color filter array;

FIG. 16 is a schematic illustration of an exemplary image frame output by the single image sensor described in connection with FIG. 8;

FIG. 17 is a schematic illustration of an exemplary image frame output by the single image sensor described in connection with FIG. 9; and

FIG. 18 is a schematic illustration of four exemplary linear polarization filters.

### DETAILED DESCRIPTION

Disclosed herein are systems, methods, and devices for 3D digital visualization with a single image sensor and a single lens assembly. The systems, methods, and devices described herein utilize the same space as traditional non-3D cameras and thus may be utilized in space constrained environments such as endoscopes.

The systems, methods, and devices described herein utilize a single image sensor and a single lens assembly, such that both left and right image channels utilize the same optical path and optical-to-electrical conversion. As such, the 3D imaging systems described herein are naturally self-aligned, and all parameters between the left and right channels are naturally identical. Additionally, the 3D digital imaging systems described herein are not based upon physical separation between left and right channels but instead based upon filtering separation. The left and right channels are projected simultaneously on an image sensor such that no mechanical separation of the channels is required.

Before the systems, methods, and devices are disclosed and described, it is to be understood that this disclosure is not limited to the particular structures, configurations, process steps, and materials disclosed herein as such structures, configurations, process steps, and materials may vary somewhat. It is also to be understood that the terminology employed herein is used for the purpose of describing particular embodiments only and is not intended to be limited since the scope of the disclosure will be limited only by the appended claims and equivalents thereof.

In describing and claiming the subject matter of the disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterized by,” and grammatical equivalents thereof are inclusive or open-ended terms that do not exclude additional, unrecited elements or method steps.

As used herein, the phrase “consisting of” and grammatical equivalents thereof exclude any element or step not specified in the claim.

As used herein, the phrase “consisting essentially of” and grammatical equivalents thereof limit the scope of a claim to the specified materials or steps and those that do not materially affect the basic and novel characteristic or characteristics of the claimed disclosure.

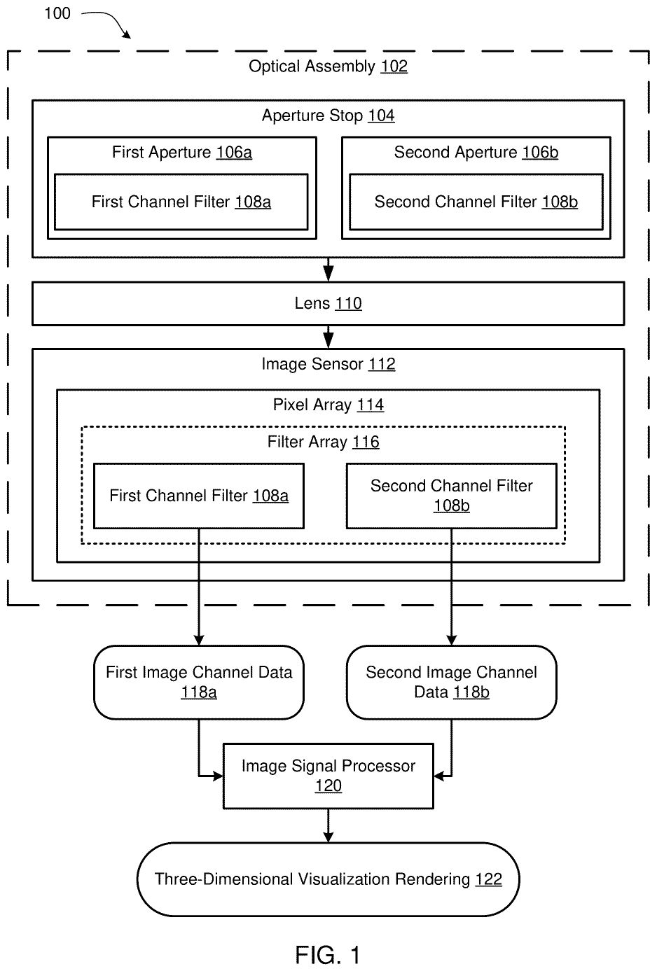

Referring now to the figures, FIG. 1 is a schematic block diagram of a system 100 for capturing 3D visualization data with a single image sensor. The system 100 includes an optical assembly 102 that is utilized to output a plurality of image channels. The data from the plurality of image channels may be processed by an image signal processor 120 to output a three-dimensional visualization rendering 122 based upon data captured by the single image sensor.

Because the optical assembly 102 includes only one image sensor 112, the optical assembly 102 is uniquely suited to provide the three-dimensional visualization rendering 122 while located within a space constrained environment, such as within the rigid or flexible tube of a scope. The scope may be intended for medical use during a minimally invasive surgical procedure. In this case, the optical assembly 102 may be disposed within the tube of any of an endoscope, colonoscope, sigmoidoscope, capsule endoscope, cystoscope, nephroscope, bronchoscope, arthroscope, laparoscope, and so forth. The scope may be intended for non-medical use and may be utilized to visualize a scene within a small or inaccessible space.

The optical assembly 102 includes an aperture stop 104 that comprises at least a first aperture 106a and a second aperture 106b. The first aperture 106a comprises a first channel filter 108a and the second aperture comprises a second channel filter 108b. The aperture stop 104 is a physical opening in the optical assembly 102 that permits EMR to pass through the lens 110 and ultimately irradiate the image sensor 112. The first and second apertures 106a, 106b of the aperture stop 104 may comprise a fixed opening size. Alternatively, one or more of the first or second apertures 106a, 106b may include an adjustable diaphragm to change the opening size.

The first aperture 106a comprises a first channel filter 108a. The first channel filter 108a may specifically include a linear polarization filter that transmits only EMR comprising a first polarization. The first channel filter 108a may include a circular polarization filter that converts linearly polarized EMR into circularly polarized EMR; a narrow waveband filter that transmits only EMR within an identified narrow waveband; a broad waveband filter that transmits only EMR within an identified broad waveband; or an anaglyph color patterning filter.

The second aperture 106b comprises a second channel filter 108b. Like the first channel filter 108a, the second channel filter 108b may also specifically include a linear polarization filter that transmits only EMR comprising a second polarization. The second channel filter 108b may include a circular polarization filter that converts linearly polarized EMR into circularly polarized EMR; a narrow waveband filter that transmits only EMR within an identified narrow waveband; or a broad waveband filter that transmits only EMR within an identified broad waveband; or an anaglyph color patterning filter.

The first and second channel filters 108a, 108b comprise the same type of filter. The first and second channel filters 108a, 108b may each comprise a linear polarization filter, or a circular polarization filter, a waveband filter, or an anaglyph color patterning filter.

If the first and second channel filters 108a, 108b each comprise a linear polarization filter, then the first channel filter 108a transmits only EMR comprising a first polarization and the second channel filter 108b transmits only EMR comprising a second polarization. In this implementation, the first polarization is orthogonal to the second polarization within a threshold of ten percent. Linear polarization filters are a type of optical device that transmits only EMR waves vibrating in a specific direction while blocking EMR waves vibrating in perpendicular directions. When unpolarized EMR (which has electric field vibrations in all planes perpendicular to the direction of travel) encounters a linear polarization filter, only the component of EMR that oscillates parallel to the filter's transmission axis is permitted to pass through the filter. The remaining EMR is absorbed or reflected.

The optical assembly 102 further includes a lens 110 and an image sensor 112. The image sensor 112 includes a pixel array 114 equipped with a filter array 116. The filter array 116 includes at least the first channel filter 108a and the second channel filter 108b. The first channel filter 108a of the filter array 116 is the same type of filter as the first channel filter 108a of the aperture stop 104. Likewise, the second channel filter 108b of the filter array 116 is the same type of filter as the second channel filter 108b of the aperture stop 104. Thus, if the first and second channel filters 108a, 108b comprise linear polarization filters, then the filter array 116 includes linear polarization filters that are orthogonal relative to one another within a tolerance threshold of ten percent.

The image sensor 112 outputs pixel accumulation data indicating an amount of EMR accumulated by the pixel wells of the pixel array 114. The pixel accumulation data comprises first image channel data 118a, which is output by the pixels equipped with the first channel filter 108a. The pixel accumulation data further comprises second image channel data 118b, which is output by the pixels equipped with the second channel filter 108b. The image channel data 118a, 118b is fed to an image signal processor 120. The image signal processor 120 outputs a three-dimensional visualization rendering 122 based upon the first and second image channel data 118a, 118b.

The system 100 is utilized to output a 3D visualization rendering based upon image data captured by a single image sensor 112. There are two main optical parameters relative to 3D visualization, including (a) the convergence distance (or zero parallax distance); and (b) focus. The human brain prefers to optimize both parameters simultaneously when dealing with an object in space. The brain places the object at the convergence distance by toeing in the eyes and makes the best focus to that object by adjusting the eye lens. The correct depth perception and 3D comfort depend upon how these parameters are set or changed with the 3D system.

Conventional binocular camera systems change the convergence distance by toeing in the two cameras or laterally shifting the image sensor position with respect to the lens. However, the focus does not change as it is independent from the convergence setting and only depends upon each camera's f-stop, and further upon the distance of the image sensor to the lens. Thus, when the convergence distance is changed, the conventional binocular camera system may output non-optimal focus. This confuses the human brain and may lead to headache, nausea, and sometimes the loss of brain 3D image fusion. Thus, conventional 3D imaging systems are often factory-tuned for a given convergence distance, and the focus is optimized at that distance. These parameters are often fixed and never changed.

The system 100 described herein addresses many of the drawbacks discussed above associated with conventional binocular camera systems. The system 100 is designed to build a 3D effect from a lack of focus and make the convergence distance and the optimal focus fully correlated. If one parameter is changed, the other parameter is automatically changed to its optimal setting.

The system 100 may further be utilized to simultaneously output 2D and 3D imaging data. This imaging data may be processed by the image signal processor 120 to calculate the three-dimensional visualization rendering 122 and additionally calculate a two-dimensional visualization rendering. The two renderings may be provided to different systems or provided to different displays. In an example implementation, the two-dimensional visualization rendering is provided to a display to be viewed by a surgeon, and the three-dimensional visualization rendering is provided to one or more computer software programs to calculate spatial parameters for a surgical scene in real-time. In another example implementation, the three-dimensional visualization rendering is provided to a three-dimensional display to be viewed by a surgeon during surgery, and the two-dimensional visualization rendering is provided to a display to be viewed by a nurse.

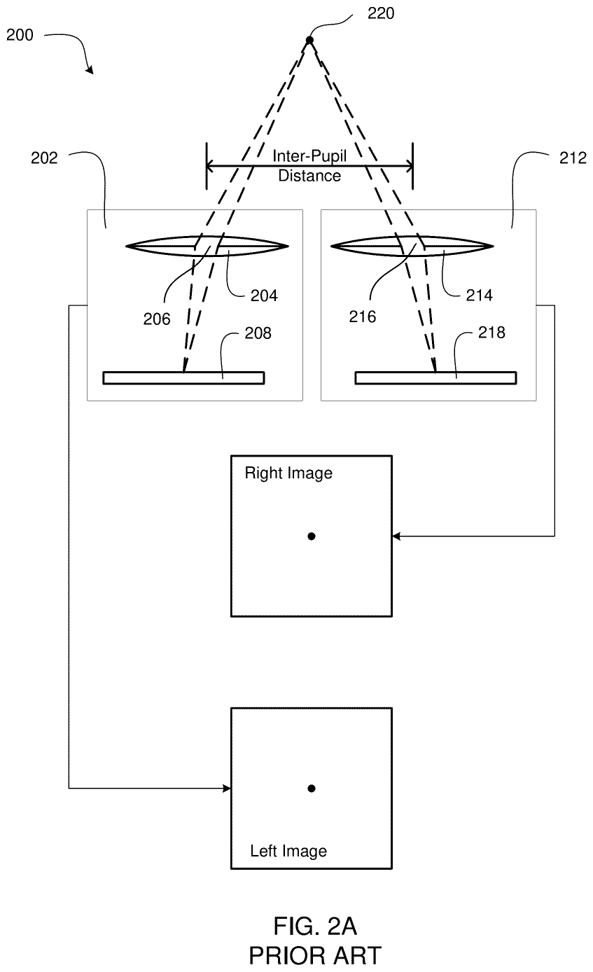

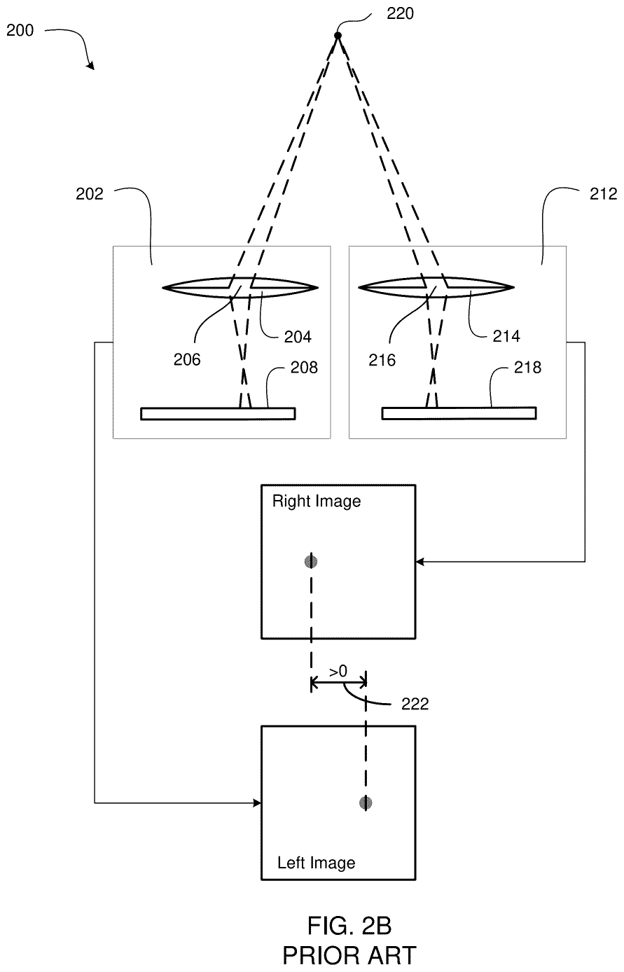

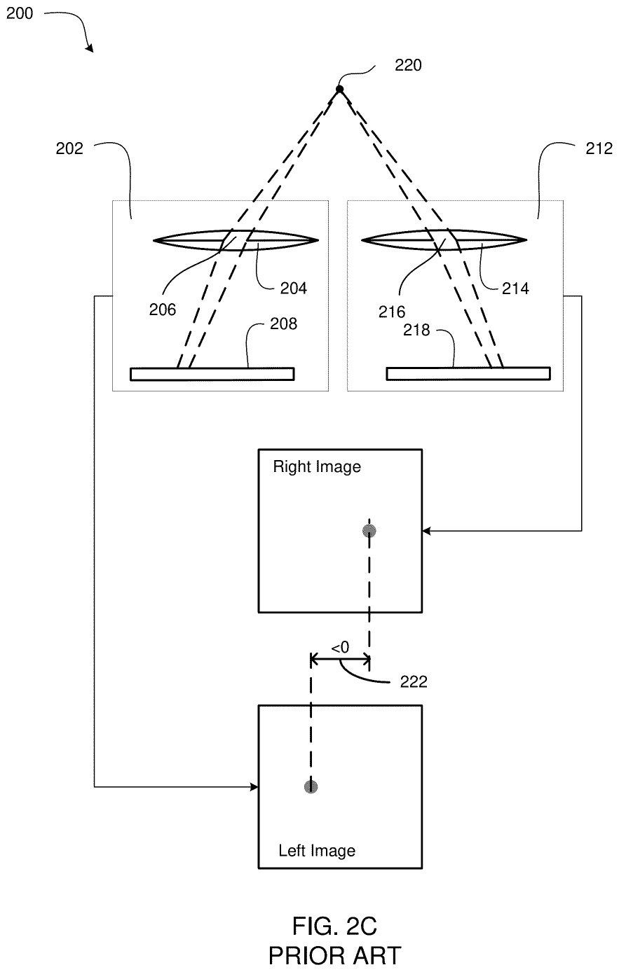

FIGS. 2A-2C are schematic illustrations of exemplary conventional binocular imaging systems configured to output 3D imaging data. FIG. 2A is a schematic illustration of a conventional binocular imaging system 200, wherein an object is placed at a convergence distance and object images are disposed at a same location on both left and right image sensors. FIG. 2B is a schematic illustration of a binocular imaging system 200 comprising two camera systems, wherein an object is placed beyond a convergence point such that object images are at different locations on left and right image sensors. FIG. 2C is a schematic illustration of a binocular imaging system 200 comprising two camera systems, wherein an object is placed between a convergence point and the cameras such that object images are at a different location on left and right image sensors.

The system 200 illustrated in FIGS. 2A-2C includes a first camera 202 and a second camera 212. The first camera 202 includes a first lens 204 comprising a first aperture 206. The left camera 202 additionally includes a first image sensor 208. The second camera 212 includes a second lens 214 comprising a second aperture 216. The second camera 212 additionally includes a second image sensor 218. The first camera 202 is located adjacent to the second camera 212 such that the first and second image sensors 208, 218 are located an inter-pupil distance away from one another. The first image sensor 208 outputs a left image and the second image sensor 218 outputs a right image.

When an object 220 is placed at a convergence distance as shown in FIG. 2A, the left and right images are identical and can be superimposed upon one another. The ideal focus for the left and right images depends upon the lens apertures 206, 216 of the first and second cameras 202, 212. The ideal focus additionally depends upon a distance between the first image sensor 208 and the first lens 204 and further based upon a distance between the second image sensor 218 and the second lens 214.

When the object 220 is placed beyond the convergence distance as shown in FIG. 2B, a parallax 222 for the left and right images is positive. The parallax 222 indicates a distance between the left and right images based upon the left and right images moving in opposite directions along a mechanical axis of the first and second cameras 202, 212.

When the object 2220 is placed in between the convergence distance and the first and second cameras 202, 212 as shown in FIG. 2C, the parallax 222 for the left and right images is negative.

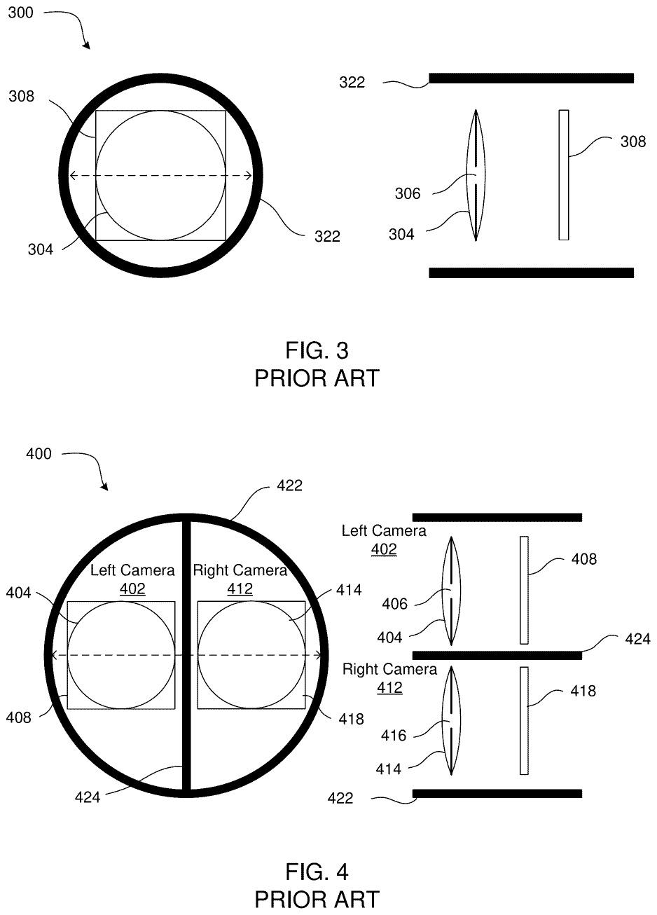

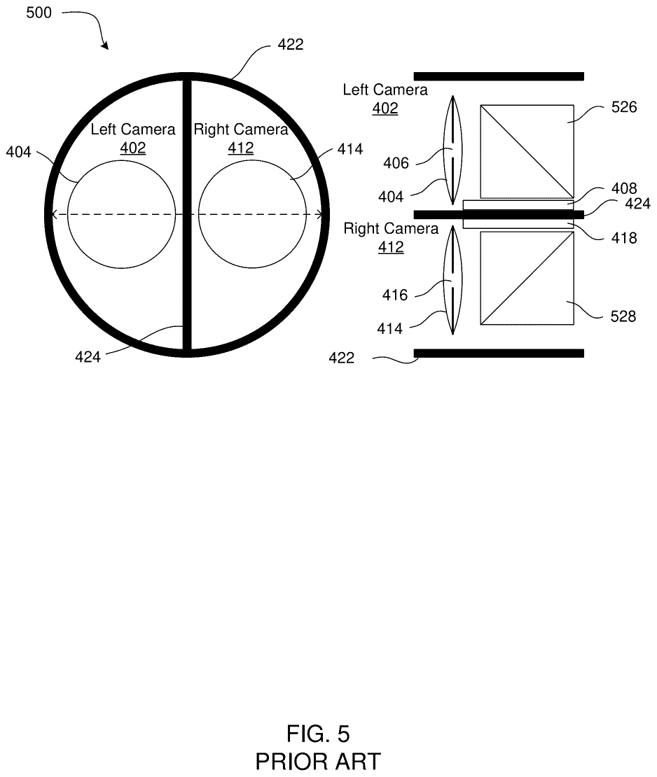

FIGS. 3-5 are schematic illustrations of camera systems known in the prior art. FIG. 3 is a schematic illustration of a system 300 for two-dimensional (2D) visualization of a scene. FIG. 4 is a schematic illustration of a system 400 for 3D visualization of a scene based upon imaging data output by left and right cameras. FIG. 5 is a schematic illustration of a system 500 for 3D visualization of a scene based upon imaging data output by left and right cameras.

The system 300 illustrated in FIG. 3 includes a lens 304 comprising an aperture 306 and further includes an image sensor 308. Each of these components is disposed within an enclosure 322. The enclosure 322 of the system 300 for 2D visualization with a single image sensor is significantly smaller than the enclosure 422 for the systems 400, 500 for 3D visualization with two cameras, as shown in FIGS. 4 and 5.

The system 400 illustrated in FIG. 4 includes a left camera 402 and a right camera 412. The left camera 402 includes a lens 404 comprising an aperture 406 and additionally includes an image sensor 408. The right camera 412 includes a lens 414 comprising an aperture 416 and additionally includes an image sensor 418. Components of each of the left camera 402 and the right camera 412 are disposed within an enclosure 422. The enclosure 422 may include a physical barrier 424 disposed in between the left camera 402 and the right camera 412.

The system 500 illustrated in FIG. 5 includes the same camera components described in connection with FIG. 4 and additionally includes a fold cube or prism mirror 526 associated with a left camera 402, and a fold cube or prism mirror 528 associated with the right camera 412. The system 500 is differentiated from the system 400 because the image sensors 408, 418 of the left and right cameras 402, 412 are folded back-to-back on to the physical barrier 424. The light path is thus folded by ninety degrees using the fold cubes or prism mirrors 526, 528. Because the optical elements of the lens can be reduced in size, this technique allows to reduce the overall endoscope diameter. However, this embodiment has two significant drawbacks, including: (a) a loss in resolution because the fold cube being glued to the sensor and has a smaller size; and (b) the alignment complexity to make both channels optically identical.

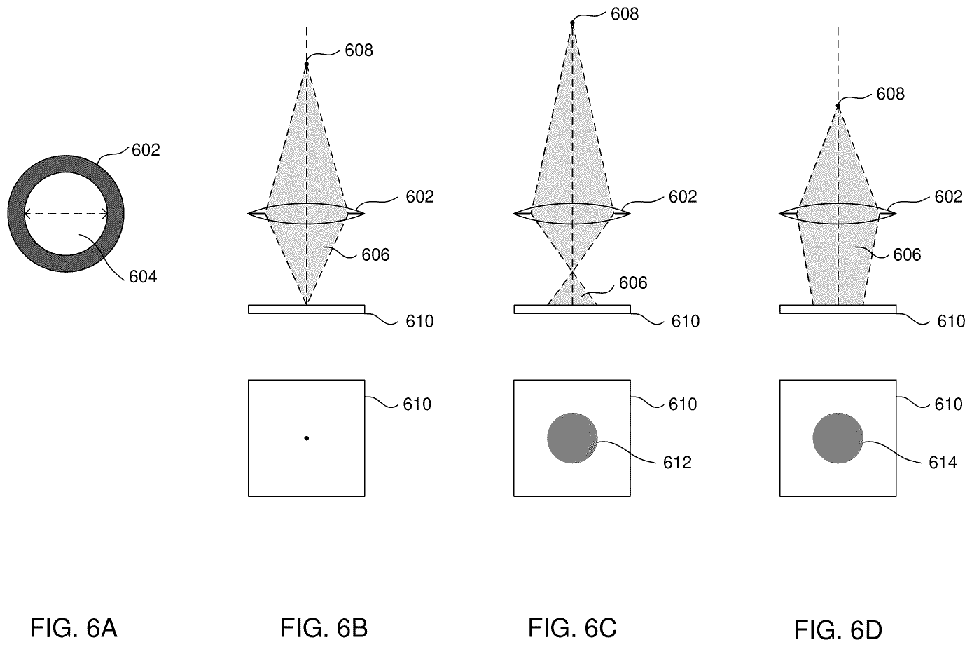

FIGS. 6A-6D are schematic illustrations depicting the ray tracing of a single thin lens. The ray tracing illustrated in FIGS. 6A-6D may also be applied to a thick lens or multi-element lens.

As shown in FIGS. 6A-6D, an aperture stop 602 is placed at the lens's aperture stop or at one of its conjugate pupil planes. The diameter of the aperture 604 determines the amount of light passing through the lens and the size of the ray bundle 606. A larger aperture diameter results in a wider ray bundle and a greater cone angle.

In FIG. 6B, an object 608 is placed on the optical axis at a distance such that all rays of the cone converge at a single point on the image sensor 610, achieving optimal focus. If the object is moved farther (see FIG. 6C) or closer (see FIG. 6D) from the focal plane, the image will no longer be a sharp point but instead form a blurred disk or circle of confusion 612, 614. The disclosure is based on the properties of the aperture stop and the circles of confusion. The relationship between the object plane (the scene) and the pupil plane, where the aperture stop is located, is fundamentally governed by a Fourier transformation. As such, the aperture stop converts spatial coordinates in object space into an angular ray distribution (or relative ray angles) with respect to the chief ray. All chief rays from different points in the scene pass through the center of the aperture stop, which serves as the reference point (0,0). Additionally, all rays within bundles that share the same angular relationship with their respective chief ray passe through the aperture stop at the same location.

In the FIGS. 6A-6D example, the “right part” of the ray bundle 606 with negative angles represents the “right view” of the object 608 at the aperture stop 602 and the “left part” of the ray bundle 606 with positive angles represents the “left view” of the object 608 at the aperture stop 602. When projected onto the image sensor 610, the right and left view locations on the image depend on the distance of the object 608 to the lens.

In the case of FIG. 6B, the right and left views are projected at the same single point location and are indistinguishable. If the object is closer to the lens (see FIG. 6D), the right part of the circle of confusion represents the right part of the object whereas the left part of the circle of confusion represents the left part of the object. If the object is farther to the focal plane (see FIG. 6C), the right part of the circle of confusion represents the left part of the object whereas the left part of the circle of confusion represents the right part of the object. This is due to the crossing of the ray bundle between the lens and the image sensor.

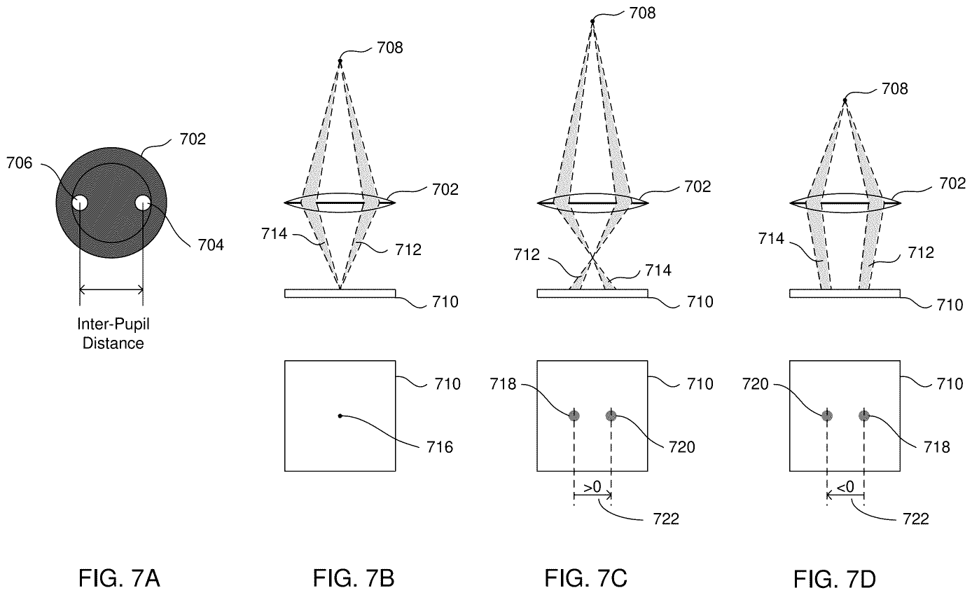

FIGS. 7A-7D are schematic illustrations of a means for optically separating left and right channels of a binocular imaging system. The aperture stop 602 of FIG. 6A is replaced by the aperture stop 702 of FIG. 7A. Two apertures are placed right and left of the aperture stop, further limiting the ray bundle. Note that the chief ray (optical axis in this example) is blocked by the new aperture stop 702. The first aperture 704 allows only the right meridional ray bundle 712 to go through the lens while the second aperture 706 allows only the left meridional ray bundle 714 to go through the lens.

As shown in FIG. 7B, when the object 708 is placed at the focal plane, the projected images from the first and second apertures superimpose at the image sensor 710. If the object 708 is moved farther (see FIG. 7C) or closer (see FIG. 7D) from the focal plane, the projected image is composed of a right and a left image. The right image 718 originates from the first aperture 704 and the left image 720 originates from the second aperture 706. The distance between the right and left images represents the parallax 722 and correlates to the distance of the object with respect to the lens.

If the object 708 is closer to the lens (see FIG. 7D), the right image 718 is on the right side of the image sensor 710 and the left image 720 is on the left side of the image sensor 710, making the parallax 722 negative. If the object is farther to the focal plane (see FIG. 7C), the right image 718 is on the left side of the image sensor 710 and the left image 720 is on the right side of the image sensor 710, making the parallax 722 positive. The parallax 722 in FIG. 7B is zero and the object 708 is said to be placed at the convergence plane. This is an important property of this disclosure as the convergence and focal planes are tied together (unlike conventional binocular vision cameras). It is mimicking ideally the human binocular vision where the brain toes in the eyes to place the convergence point or zero-parallax at one object while adjusting the focus to that object by controlling the shape of the lens using the ciliary muscles. The distance between the two apertures seen at the entrance pupil is the inter-pupil distance or IPD and reflects the power of the 3D effect. The larger the aperture 604 or the distance between first and second apertures 704, 706, the larger the circle of confusion for an object at a given distance 612, 614, the more separated are the right and left images 718, 720, the more 3D effect. It should be noted that the two images form a blurry disk that depends on the diameter (or f-stop) of the apertures 704, 706 as for any optical system. The aperture 602 and apertures 704, 706 are independent. The aperture 704, 706 diameters define the left and right channels f-stop (depth of field and amount of light going through the lens) whereas the aperture 602 diameter controls the inter-pupil distance (3D strength). In this example the apertures 704, 706 are circular but can have other shapes like oblong shape or crescent moon shape.

From FIGS. 7A-7D, the right and left images have been optically separated. However, they merge at the image sensor level and each pixel or detecting element of the image sensor is sensitive to both the right and left images.

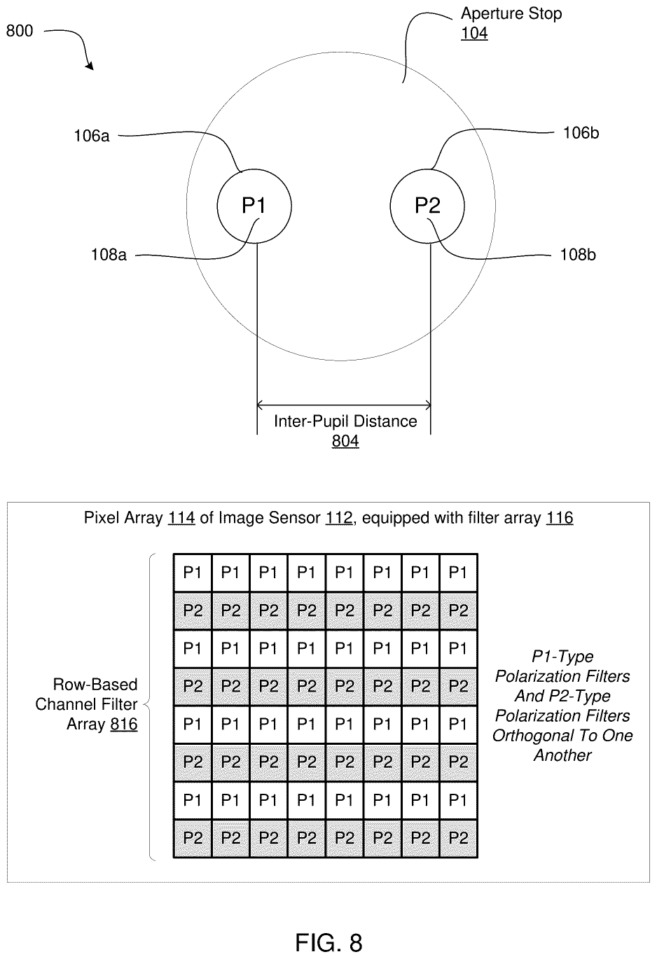

FIGS. 8-15 are schematic illustrations of optical assemblies for capturing 3D visualization data with a single image sensor and a single lens. The optical assemblies may be located within a space constrained environment, such as a tube of a scope that may be utilized to capture visualization data during a minimally invasive surgical procedure. The optical assemblies output first and second image channel data (see 118a, 118b at FIG. 1) that may be processed by an image signal processor (see 120 at FIG. 1) to output a three-dimensional visualization rendering (see 122 at FIG. 1). The optical assemblies output the first and second image channel data with only one image sensor and one lens assembly.

Each of the optical assemblies illustrated in FIGS. 8-15 includes an image sensor 112 comprising a pixel array 114, wherein the pixel array 114 is equipped with a filter array (see 116 at FIG. 1). The optical assemblies include different pixel filter arrangements for the filter array 116.

Additionally, each of the optical assemblies illustrated in FIGS. 8-15 includes a lens (not shown, see 104 at FIG. 1) equipped with an aperture stop 104. The aperture stop 104 is a physical opening or diaphragm controlling an amount of EMR permitted to pass through the lens 110 and ultimately irradiate the pixel array 114 of the image sensor 112. The aperture stop 104 determines an effective diameter of a light beam that can pass through the lens 110. Additionally, the aperture stop 104 controls an amount of EMR reaching the image sensor 112, impacts the depth of field of resultant image data, reduces optical aberrations by blocking peripheral EMR rays, and influences image contrast and sharpness.

The aperture stop 104 comprises a first aperture 106a and a second aperture 106b. The first and second apertures 106a, 106b may comprise a circular geometry as shown in FIGS. 8-15. Alternatively, one or more of the first or second apertures 106a, 106b may include an alternative geometry, such as an elliptical, oblong, or crescent geometry. The first aperture 106a and the second aperture 106b are separated by an inter-pupil distance 804. The first aperture 106a comprises a first channel filter 108a, and the second aperture 106b comprises a second channel filter 108b. The first and second channel filters 108a, 108b may include any of a linear polarization filter, or a circular polarization filter, a waveband filter, or an anaglyph color patterning filter.

If the first and second channel filters 108a, 108b include linear polarization filters, then the first channel filter 108a transmits only EMR that is orthogonal to the EMR transmitted by the second channel filter 108b, within a tolerance threshold of ten percent. This ensures that EMR passing through the first channel filter 108a is orthogonally polarized relative to EMR passing through the second channel filter 108b.

FIG. 8 is a schematic illustration of components of an optical assembly 800 for capturing 3D visualization data with a single image sensor and a single lens. The image sensor 112 of the optical assembly 800 includes a pixel array 114 equipped with a row-based channel filter array 816 (may be referred to as the filter array 816 for brevity). The first channel filter 108a comprises a “P1” filter type, and the second channel filter 108b comprises a “P2” filter type.

The P1 and P2 filter types may include linear polarization filters. The P1 and P2 filter types may include circular polarization filters. The P1 and P2 filter types may include waveband filters or anaglyph color patterning filters. If the P1 and P2 filters include linear polarization filters, then the P1 filter type is orthogonal relative to the P2 filter type. Likewise, the filter array 816 includes the same filter types as the aperture stop 104, such that the filter array 816 includes P1 and P2 filter types.

The pixel array 114 includes a plurality of pixels, and at least a portion of the plurality of pixels is equipped with a filter of the filter array. The filter array 816 arranges the polarization filters P1, P2 according to pixel rows. In the example illustrated in FIG. 8, odd pixel rows are equipped with the P1 filter, and even pixel rows are equipped with the P2 filter.

The optical assembly 800 functions such that EMR passing through the first channel filter 108a comprising the P1 filter type will irradiate only the odd numbered pixel rows equipped with the P1 filter type. Additionally, EMR passing through the second channel filter 108b comprising the P2 filter type will irradiate only the even numbered pixel rows equipped with the P2 filter type. The odd numbered pixel rows equipped with the P1 filter type are blind to EMR passing through the second aperture polarization filter 108b. Likewise, the even numbered pixel rows equipped with the P2 filter type are blind to EMR passing through the first aperture polarization filter 108a.

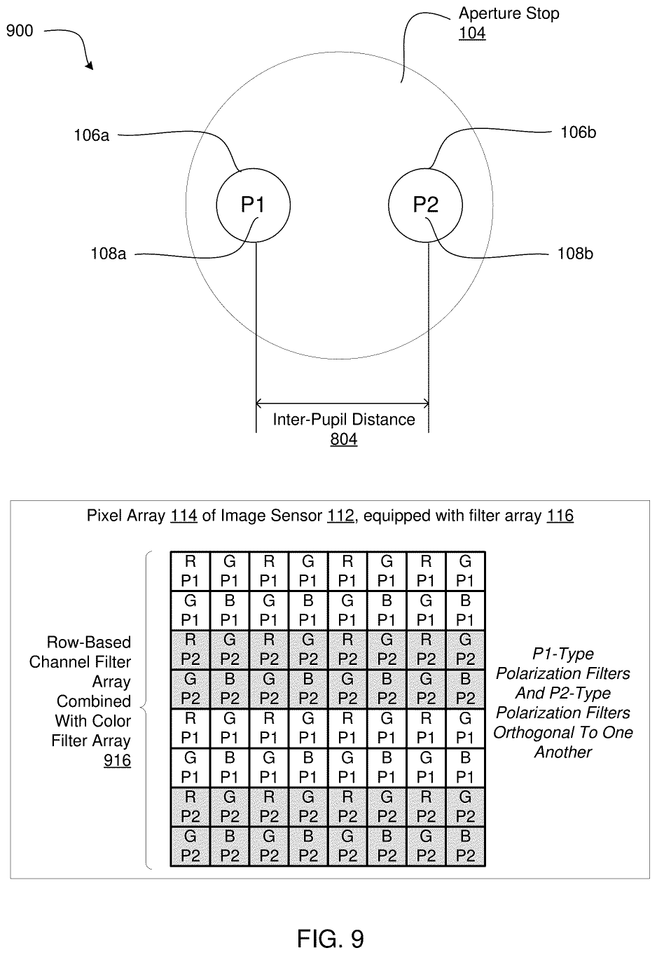

FIG. 9 is a schematic illustration of components of an optical assembly 900 for capturing 3D visualization data with a single image sensor and a single lens. The image sensor 112 of the optical assembly 900 includes a pixel array 114 equipped with a row-based channel filter array combined with a color filter array 916 (may be referred to as the filter array 916 for brevity). The first channel filter 108a comprises a “P1” filter type, and the second channel filter 108b comprises a “P2” filter type.

The P1 and P2 filter types may include linear polarization filters. The P1 and P2 filter types may include circular polarization filters. The P1 and P2 filter types may include waveband filters or anaglyph color patterning filters. If the P1 and P2 filters include linear polarization filters, then the P1 filter type is orthogonal relative to the P2 filter type. Likewise, the filter array 916 includes the same filter types as the aperture stop 104, such that the filter array 916 includes P1 and P2 filter types in addition to color filter types for the color filter array.

The filter array 916 includes a color filter array designed to enable the image sensor 112 to output color visualization data. The exemplary filter array 916 illustrated in FIG. 9 includes a Bayer pattern color filter array, but the type and arrangement of the color filter array may be adjusted depending upon the implementation. The Bayer pattern color filter array illustrated in FIG. 9 includes red, green, and blue color filters arranged in repeating 2×2 pixel blocks, wherein each 2×2 pixel block includes one red filter, two green filters, and one blue filter.

The filter array 916 may be arranged such that the color filters are overlaid on the P1 and P2 channel filters. Alternatively, the filter array 916 may be arranged such that P1 and P2 channel filters are overlaid on the color filters.

Because each repeating 2×2 pixel block is two rows in height, the row-based polarization filter arrangement is likewise based upon two rows. Thus, the first and second rows of the pixel array 114 (i.e., the first odd numbered row of 2×2 pixel blocks in the Bayer pattern color filter array) comprises the P1 polarization filter. Further, the third and fourth rows of the pixel array 114 (i.e., the first even numbered row of 2×2 pixel blocks in the Bayer pattern color filter array) comprises the P2 polarization filter. This arrangement ensures that each 2×2 pixel block in the Bayer pattern color filter array comprises the same polarization filter type for all four pixels within the pixel block.

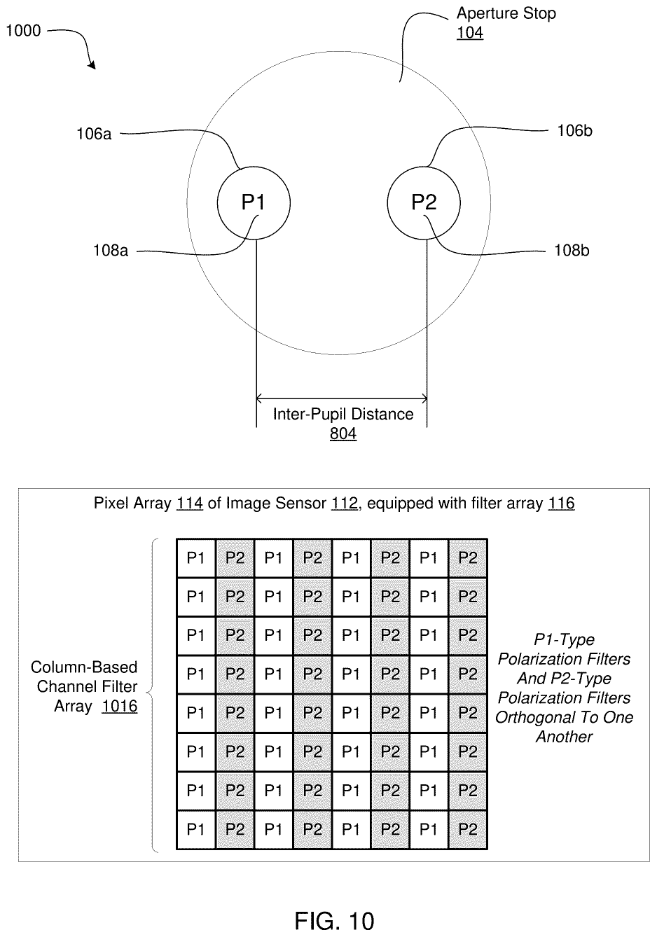

FIG. 10 is a schematic illustration of components of an optical assembly 1000 for capturing 3D visualization data with a single image sensor and a single lens. The image sensor 112 of the optical assembly 1000 includes a pixel array 114 equipped with a column-based channel filter array 1016 (may be referred to as the filter array 1016 for brevity). The first channel filter 108a comprises a “P1” filter type, and the second channel filter 108b comprises a “P2” filter type.

The P1 and P2 filter types may include linear polarization filters. The P1 and P2 filter types may include circular polarization filters. The P1 and P2 filter types may include waveband filters or anaglyph color patterning filters. If the P1 and P2 filters include linear polarization filters, then the P1 filter type is orthogonal relative to the P2 filter type. Likewise, the filter array 1016 includes the same filter types as the aperture stop 104, such that the filter array 1016 includes P1 and P2 filter types.

The filter array 1016 arranges the polarization filters P1, P2 according to pixel columns. In the example illustrated in FIG. 10, odd numbered pixel columns are equipped with the P1 filter, and even numbered pixel columns are equipped with the P2 filter.

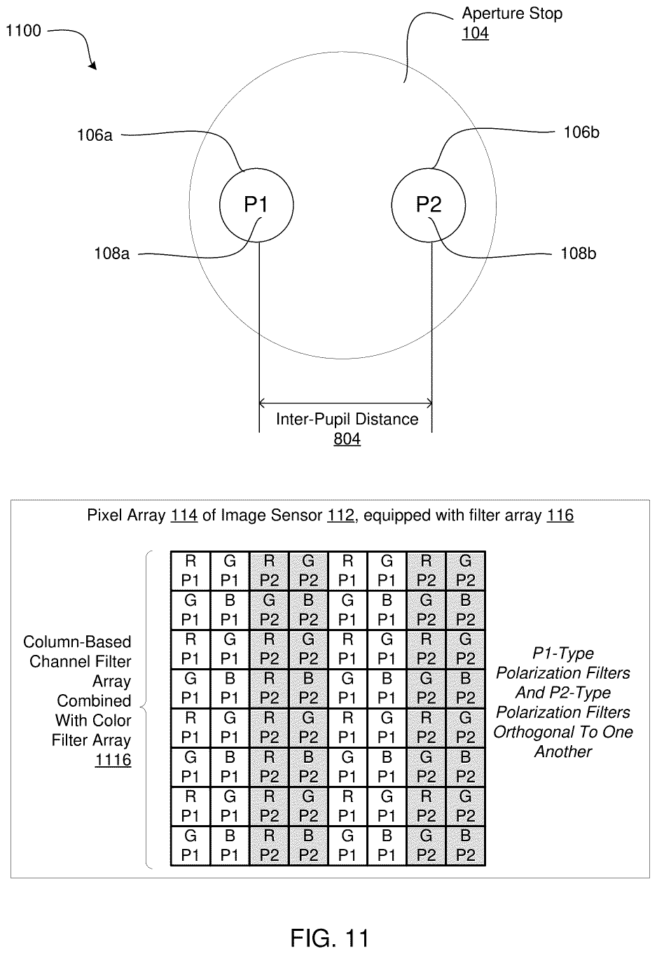

FIG. 11 is a schematic illustration of components of an optical assembly 1100 for capturing 3D visualization data with a single image sensor and a single lens. The image sensor 112 of the optical assembly 1100 includes a pixel array 114 equipped with a column-based channel filter array combined with a color filter array 1116 (may be referred to as a filter array 1116 for brevity). The first channel filter 108a comprises a “P1” filter type, and the second channel filter 108b comprises a “P2” filter type.

The P1 and P2 filter types may include linear polarization filters. The P1 and P2 filter types may include circular polarization filters. The P1 and P2 filter types may include waveband filters or anaglyph color patterning filters. If the P1 and P2 filters include linear polarization filters, then the P1 filter type is orthogonal relative to the P2 filter type. Likewise, the filter array 1116 includes the same filter types as the aperture stop 104, such that the filter array 1116 includes P1 and P2 filter types in addition to color filter types for the color filter array.

The filter array 1116 includes a color filter array designed to enable the image sensor 112 to output color visualization data. The exemplary filter array 1116 illustrated in FIG. 11 includes a Bayer pattern color filter array, but the type and arrangement of the color filter array may be adjusted depending upon the implementation. The Bayer pattern color filter array illustrated in FIG. 11 includes red, green, and blue color filters arranged in repeating 2×2 pixel blocks, wherein each 2×2 pixel block includes one red filter, two green filters, and one blue filter.

The filter array 1116 may be arranged such that the color filters are overlaid on the P1 and P2 channel filters. Alternatively, the filter array 1116 may be arranged such that P1 and P2 channel filters are overlaid on the color filters.

Because each repeating 2×2 pixel block is two columns in width, the column-based polarization filter arrangement is likewise based upon two columns. Thus, the first and second columns of the pixel array 114 (i.e., the first odd numbered column of 2×2 pixel blocks in the Bayer pattern color filter array) comprises the P1 polarization filter. Further, the third and fourth columns of the pixel array 114 (i.e., the first even numbered column of 2×2 pixel blocks in the Bayer pattern color filter array) comprises the P2 polarization filter. This arrangement ensures that each 2×2 pixel block in the Bayer pattern color filter array comprises the same polarization filter type for all four pixels within the pixel block.

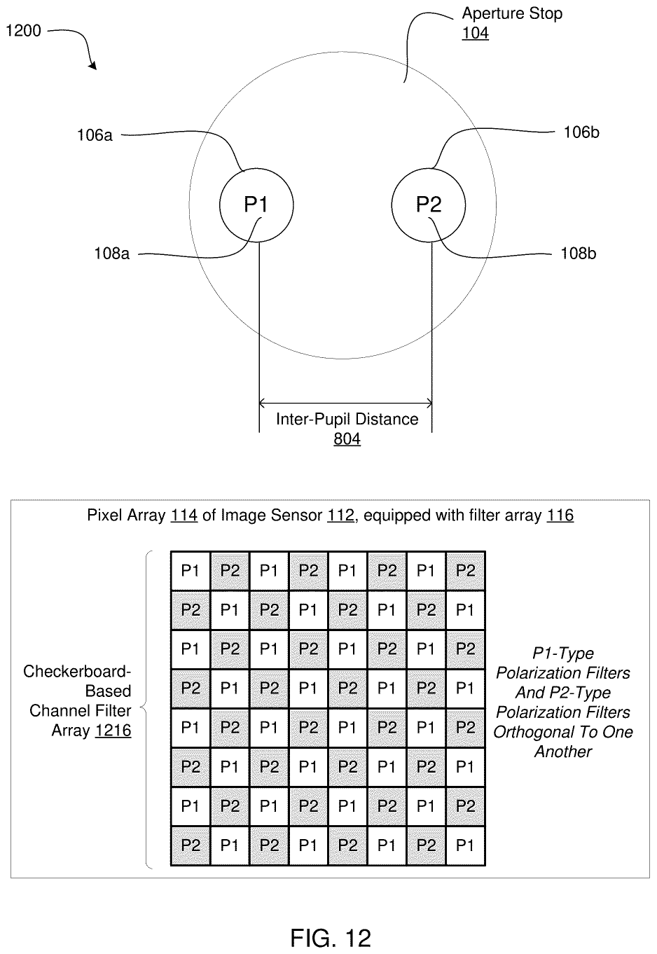

FIG. 12 is a schematic illustration of components of an optical assembly 1200 for capturing 3D visualization data with a single image sensor and a single lens. The image sensor 112 of the optical assembly 1200 includes a pixel array 114 equipped with a checkerboard-based channel filter array 1216 (may be referred to as a filter array 1216 for brevity). The first channel filter 108a comprises a “P1” filter type, and the second channel filter 108b comprises a “P2” filter type.

The P1 and P2 filter types may include linear polarization filters. The P1 and P2 filter types may include circular polarization filters. The P1 and P2 filter types may include waveband filters or anaglyph color patterning filters. If the P1 and P2 filters include linear polarization filters, then the P1 filter type is orthogonal relative to the P2 filter type. Likewise, the filter array 1216 includes the same filter types as the aperture stop 104, such that the filter array 1216 includes P1 and P2 filter types.

The filter array 1216 includes the P1 and P2 filter types arranged in checkerboard pattern as shown, such that each P1 filter is surrounded on its sides by P2 filters, and likewise such that each P2 filter is surrounded on its sides by P1 filters. The filter array 1216 distributes the P1 and P2 filter types throughout the pixel array 114, rather than on a per-row or per-column basis.

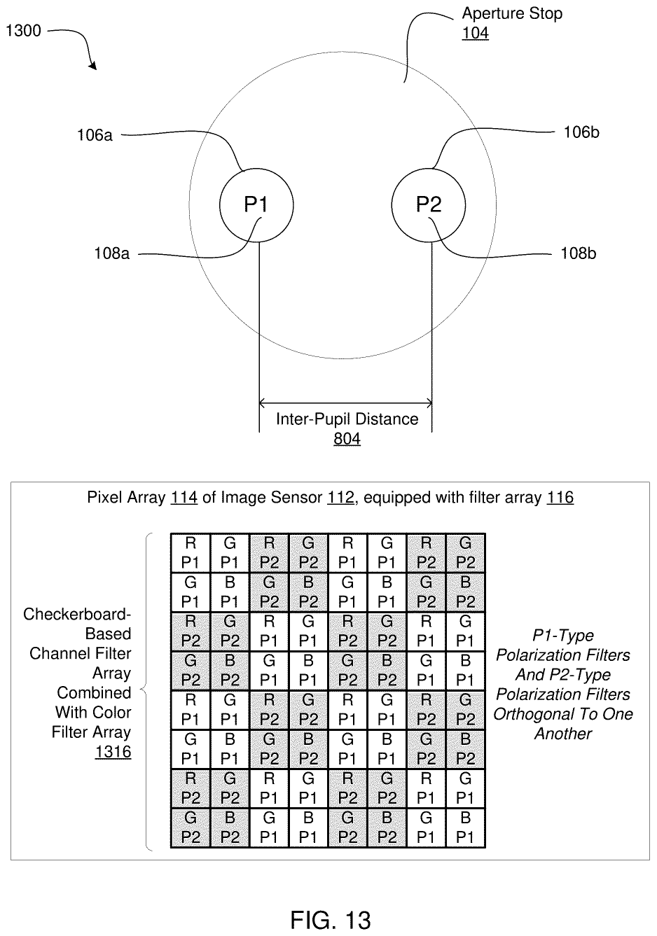

FIG. 13 is a schematic illustration of components of an optical assembly 1300 for capturing 3D visualization data with a single image sensor and a single lens. The image sensor 112 of the optical assembly 1300 includes a pixel array 114 equipped with a checkerboard-based channel filter array combined with a color filter array 1316 (may be referred to as a filter array 1316 for brevity). The first channel filter 108a comprises a “P1” filter type, and the second channel filter 108b comprises a “P2” filter type.

The P1 and P2 filter types may include linear polarization filters. The P1 and P2 filter types may include circular polarization filters. The P1 and P2 filter types may include waveband filters or anaglyph color patterning filters. If the P1 and P2 filters include linear polarization filters, then the P1 filter type is orthogonal relative to the P2 filter type. Likewise, the filter array 1316 includes the same filter types as the aperture stop 104, such that the filter array 1316 includes P1 and P2 filter types in addition to color filter types for the color filter array.

The filter array 1316 includes a color filter array designed to enable the image sensor 112 to output color visualization data. The exemplary filter array 1316 illustrated in FIG. 13 includes a Bayer pattern color filter array, but the type and arrangement of the color filter array may be adjusted depending upon the implementation. The Bayer pattern color filter array illustrated in FIG. 13 includes red, green, and blue color filters arranged in repeating 2×2 pixel blocks, wherein each 2×2 pixel block includes one red filter, two green filters, and one blue filter.

The filter array 1316 may be arranged such that the color filters are overlaid on the P1 and P2 channel filters. Alternatively, the filter array 1316 may be arranged such that P1 and P2 channel filters are overlaid on the color filters.

The polarization filters are arranged in a checkerboard pattern on a per-pixel block basis, such that all four pixels within a 2×2 pixel block comprise the same polarization filter. Neighboring 2×2 pixel blocks are then equipped with the orthogonal polarization filter type, as shown in FIG. 13.

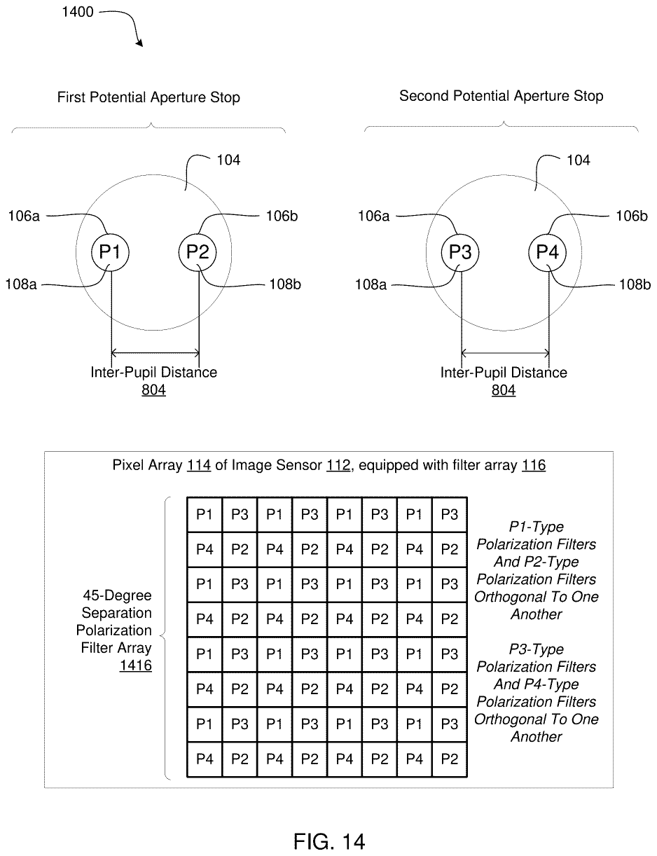

FIG. 14 is a schematic illustration of components of an optical assembly 1400 for simultaneously capturing both 2D and 3D visualization data with a single image sensor and a single lens. The image sensor 112 of the optical assembly 1400 includes a pixel array 114 equipped with a 45-degree separation polarization filter array 1416 (may be referred to as a filter array 1416 for brevity).

The optical assembly 1400 includes one of a first potential aperture stop or a second potential aperture stop. Each potential aperture stop 104 includes a first aperture 106a and a second aperture 106b that are separated by an inter-pupil distance 804. The first aperture 106a includes a first channel filter 108a, and the second aperture 106b includes a second channel filter 108b. The aperture stop 104 may include the first potential aperture stop, wherein the first channel filter 108a is a P1 filter and the second channel filter 108b is a P2 filter. The aperture stop 104 may alternatively include the second potential aperture stop, wherein the first channel filter 108a is a P3 filter and the second channel filter 108b is a P4 filter.

The P1/P2 or P3/P4 filter pairings of the aperture stop may include linear polarization filters, circular polarization filters, waveband filters, or anaglyph color patterning filters. If the first potential aperture stop filter pairing includes linear polarization filters, then the P1 filter transmits EMR that is orthogonal to the EMR transmitted by the P2 filter, within a tolerance threshold of ten percent. If the second potential aperture stop filter pairing includes linear polarization filters, then the P3 filter transmits EMR that is orthogonal to the EMR transmitted by the P4 filter, within a tolerance threshold of ten percent. In this implementation, the P1 filter is plus-or-minus 45 degrees relative to the P3 and P4 filters, and the P2 filter is also plus-or-minus 45 degrees relative to the P3 and P4 filters.

The filter array 1416 includes each of the four channel filters, including P1, P2, P3, and P4, arranged in a repeating pattern. If the four channel filters are linear polarization filters, then the repeating pattern is a 45-degree separation pattern in a clockwise or counterclockwise direction. Thus, when moving clockwise or counterclockwise, each polarization filter is plus-or-minus the previous polarization filter and plus-or-minus the next polarization filter. For example, if P1 is a zero degree polarization filter, then moving clockwise, P3 may be a 45-degree polarization filter, P2 may be a 90-degree polarization filter, and P4 may be a 135-degree polarization filter. The types of polarization filters may be adjusted depending upon the implementation and the visualization goals.

The filter array 1416 includes four distinct channel filters and the aperture stop 104 includes only two of the four distinct channel filters that are represented in the filter array 1416. If the aperture stop 104 includes the first potential aperture stop, with the P1 and P2 channel filters, then the pixel accumulation data output by the P1 and P2 pixels of the filter array 1416 are responsible for outputting the 3D visualization data. Further in this implementation, the pixel accumulation data output by the P3 and P4 pixels of the filter array 1416 is utilized to output 2D visualization data by merging the imaging data output by the P3 and P4 pixels. Thus, 2D and 3D visualization data is simultaneously output with a single image frame.

In an alternative implementation, wherein the aperture stop 104 includes the second potential aperture stop, with the P3 and P4 channel filters, then the pixel accumulation data output by the P3 and P4 pixels of the filter array 1416 are responsible for outputting the 3D visualization data. Further in this alternative implementation, the pixel accumulation data output by the P1 and P2 pixels of the filter array 1416 is utilized to output 2D visualization data by merging the imaging data output by the P1 and P2 pixels. Thus, 2D and 3D visualization data is simultaneously output with a single image frame.

When ignoring natural transmission loss for the sake of simplicity, the optical assembly 1400 functions such that 100% of polarized EMR is transmitted through a parallel polarization filter; 0% of polarized EMR is transmitted through an orthogonal polarization filter; and 50% of polarized EMR is transmitted through a 45-degree orientated polarization filter.

In the exemplary optical assembly 1400, the P1 filter is plus-or-minus 45 degrees relative to the P3 and P4 filters, and the P2 filter is also plus-or-minus 45 degrees relative to the P3 and P4 filters. If the first potential aperture stop 104 with the P1 and P2 filters is utilized, then the P3 and P4 filtered pixels of the pixel array 114 receive 50% of EMR transmitted through the P1 first channel filter 108 a of the aperture stop 104 and 50% of EMR transmitted through the P2 second channel filter 108b of the aperture stop 104. The P1 filtered pixels of the pixel array 114 receive 100% of EMR transmitted through the P1 first channel filter 108a of the aperture stop 104 and 0% of EMR transmitted through the P2 second channel filter 108b of the aperture stop 104. The P2 filtered pixels of the pixel array 114 receive 100% of EMR transmitted through the P2 second channel filter 108b of the aperture stop 104 and 0% of EMR transmitted through the P1 first channel filter 108a of the aperture stop 104.

In an alternative implementation wherein the second potential aperture stop 104 with the P3 and P4 filters is utilized, then the P1 and P2 filtered pixels of the pixel array 114 receive 50% of EMR transmitted through the P3 first channel filter 108 a of the aperture stop 104 and 50% of EMR transmitted through the P4 second channel filter 108b of the aperture stop 104. The P3 filtered pixels of the pixel array 114 receive 100% of EMR transmitted through the P3 first channel filter 108a of the aperture stop 104 and 0% of EMR transmitted through the P4 second channel filter 108b of the aperture stop 104. The P4 filtered pixels of the pixel array 114 receive 100% of EMR transmitted through the P4 second channel filter 108b of the aperture stop 104 and 0% of EMR transmitted through the P3 first channel filter 108a of the aperture stop 104.

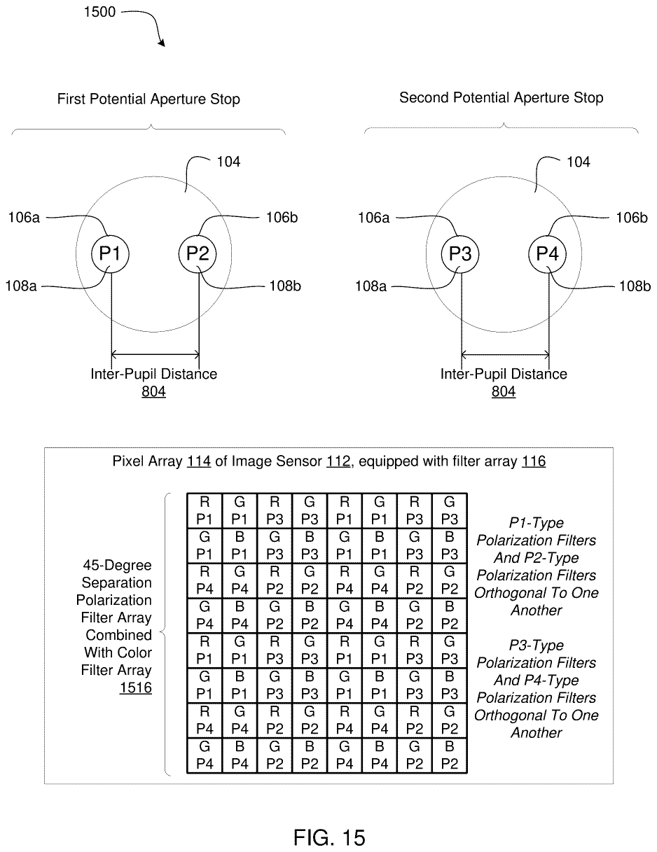

FIG. 15 is a schematic illustration of components of an optical assembly 1500 for simultaneously capturing both 2D and 3D visualization data with a single image sensor and a single lens. The image sensor 112 of the optical assembly 1500 includes a pixel array 114 equipped with a 45-degree separation polarization filter array combined with a color filter array 1516 (may be referred to as a filter array 1516 for brevity).

Like the optical assembly 1400 described in connection with FIG. 14, the optical assembly 1500 includes one of a first potential aperture stop or a second potential aperture stop. Each potential aperture stop 104 includes a first aperture 106a and a second aperture 106b that are separated by an inter-pupil distance 804. The first aperture 106a includes a first channel filter 108a, and the second aperture 106b includes a second channel filter 108b. The aperture stop 104 may include the first potential aperture stop, wherein the first channel filter 108a is a P1 filter and the second channel filter 108b is a P2 filter. The aperture stop 104 may alternatively include the second potential aperture stop, wherein the first channel filter 108a is a P3 filter and the second channel filter 108b is a P4 filter.

The P1/P2 or P3/P4 filter pairings of the aperture stop may include linear polarization filters, circular polarization filters, waveband filters, or anaglyph color patterning filters. If the first potential aperture stop filter pairing includes linear polarization filters, then the P1 filter transmits EMR that is orthogonal to the EMR transmitted by the P2 filter, within a tolerance threshold of ten percent. If the second potential aperture stop filter pairing includes linear polarization filters, then the P3 filter transmits EMR that is orthogonal to the EMR transmitted by the P4 filter, within a tolerance threshold of ten percent. In this implementation, the P1 filter is plus-or-minus 45 degrees relative to the P3 and P4 filters, and the P2 filter is also plus-or-minus 45 degrees relative to the P3 and P4 filters.

Like the optical assembly 1400 described in connection with FIG. 14, the filter array 1516 includes each of the four channel filters, including P1, P2, P3, and P4, arranged in a repeating pattern. If the four channel filters are linear polarization filters, then the repeating pattern is a 45-degree separation pattern in a clockwise or counterclockwise direction. Thus, when moving clockwise or counterclockwise, each polarization filter is plus-or-minus the previous polarization filter and plus-or-minus the next polarization filter. For example, if P1 is a zero degree polarization filter, then moving clockwise, P3 may be a 45-degree polarization filter, P2 may be a 90-degree polarization filter, and P4 may be a 135-degree polarization filter. The types of polarization filters may be adjusted depending upon the implementation and the visualization goals.

The filter array 1516 differs from the filter array 1416 described in connection with FIG. 14 because the filter array 1516 additionally includes a color filter array designed to enable the image sensor 112 to output color visualization data. The exemplary filter array 1516 illustrated in FIG. 15 includes a Bayer pattern color filter array, but the type and arrangement of the color filter array may be adjusted depending upon the implementation. The Bayer pattern color filter array illustrated in FIG. 15 includes red, green, and blue color filters arranged in repeating 2×2 pixel blocks, wherein each 2×2 pixel block includes one red filter, two green filters, and one blue filter. The filter array 1516 may be arranged such that the color filters are overlaid on the P1, P2, P3, and P4 channel filters. Alternatively, the filter array 916 may be arranged such that P1, P2, P3, and P4 channel filters are overlaid on the color filters.

The filter array 1516 includes four distinct channel filters and the aperture stop 104 includes only two of the four distinct channel filters that are represented in the filter array 1516. If the aperture stop 104 includes the first potential aperture stop, with the P1 and P2 channel filters, then the pixel accumulation data output by the P1 and P2 pixels of the filter array 1516 are responsible for outputting the 3D visualization data. Further in this implementation, the pixel accumulation data output by the P3 and P4 pixels of the filter array 1516 is utilized to output 2D visualization data by merging the imaging data output by the P3 and P4 pixels. Thus, 2D and 3D visualization data is simultaneously output with a single image frame.

In an alternative implementation, wherein the aperture stop 104 includes the second potential aperture stop, with the P3 and P4 channel filters, then the pixel accumulation data output by the P3 and P4 pixels of the filter array 1516 are responsible for outputting the 3D visualization data. Further in this alternative implementation, the pixel accumulation data output by the P1 and P2 pixels of the filter array 1516 is utilized to output 2D visualization data by merging the imaging data output by the P1 and P2 pixels. Thus, 2D and 3D visualization data is simultaneously output with a single image frame.

When ignoring natural transmission loss for the sake of simplicity, the optical assembly 1400 functions such that 100% of polarized EMR is transmitted through a parallel polarization filter; 0% of polarized EMR is transmitted through an orthogonal polarization filter; and 50$ of polarized EMR is transmitted through a 45-degree orientated polarization filter.

In the exemplary optical assembly 1500, the P1 filter is plus-or-minus 45 degrees relative to the P3 and P4 filters, and the P2 filter is also plus-or-minus 45 degrees relative to the P3 and P4 filters. If the first potential aperture stop 104 with the P1 and P2 filters is utilized, then the P3 and P4 filtered pixels of the pixel array 114 receive 50% of EMR transmitted through the P1 first channel filter 108a of the aperture stop 104 and 50% of EMR transmitted through the P2 second channel filter 108b of the aperture stop 104. The P1 filtered pixels of the pixel array 114 receive 100% of EMR transmitted through the P1 first channel filter 108a of the aperture stop 104 and 0% of EMR transmitted through the P2 second channel filter 108b of the aperture stop 104. The P2 filtered pixels of the pixel array 114 receive 100% of EMR transmitted through the P2 second channel filter 108b of the aperture stop 104 and 0% of EMR transmitted through the P1 first channel filter 108a of the aperture stop 104.

In an alternative implementation wherein the second potential aperture stop 104 with the P3 and P4 filters is utilized, then the P1 and P2 filtered pixels of the pixel array 114 receive 50% of EMR transmitted through the P3 first channel filter 108 a of the aperture stop 104 and 50% of EMR transmitted through the P4 second channel filter 108b of the aperture stop 104. The P3 filtered pixels of the pixel array 114 receive 100% of EMR transmitted through the P3 first channel filter 108a of the aperture stop 104 and 0% of EMR transmitted through the P4 second channel filter 108b of the aperture stop 104. The P4 filtered pixels of the pixel array 114 receive 100% of EMR transmitted through the P4 second channel filter 108b of the aperture stop 104 and 0% of EMR transmitted through the P3 first channel filter 108a of the aperture stop 104.

The optical assemblies described in connection with FIGS. 8-15 enable an image sensor to output a single image frame that may be processed to output a 3D visualization rendering of a scene. The optical assemblies may be utilized to capture 3D imaging data at various distances. In some cases, an optical distance of an object to be seen in 3D is about arm distance, or around one meter. An average distance between human eyes (i.e., equivalent to the inter-pupil distance 804 discussed herein) is about 6.5 centimeters. Trigonometry may be applied to calculate an optimal angle of about 3.7 degrees, and if this is scaled down to a conventional 5 centimeter working distance when utilizing a scope during a minimally invasive surgical procedure, an optimal inter-pupil distance 804 of the optical assembly (see FIGS. 8-15) is about 3 millimeters if wanting to preserve digital visualization within the “brain comfort zone.” It can be difficult to achieve such a small inter-pupil distance with a conventional binocular camera, because the inter-pupil distance is at a minimum the distance between the two image sensor centers. However, as described in connection with FIGS. 4 and 5, conventional binocular camera systems utilize a physical barrier (see 424) to prevent optical crosstalk between the cameras, and this adds additional distance between the two image sensor centers. Because of this, conventional binocular camera systems often have a non-optimal inter-pupil distance, and this results in 3D amplification and distortion, which is unnatural for the brain to process.

Any of the filter arrays described in any of the optical assemblies of FIGS. 8-15 may be modified such that the P1, P2, P3, and P4 filters are not equally distributed in the filter array. For example, if the filter array includes only P1 and P2 filters, then the P1 and P2 filters may be represented in a 50/50 ratio, as depicted in FIGS. 8-13. Alternatively, the P1 and P2 filters may be represented in alternative ratios, including ratios with more P1 filters than P2 filters, and vice versa. This equally applies to filter arrays including each of P1, P2, P3, and P4 filters, as shown in FIGS. 14-15.

The systems, methods, and devices described herein address the issues discussed above with response to a non-optimal inter-pupil distance, because a single image frame is captured on a single image sensor, so there is no need for a physical camera separation. The optical assemblies described herein could potentially include an inter-pupil distance of zero that may be utilized for 2D images. Because 3D is perceived differently by different users, the inter-pupil distance could be adjusted depending upon user preference.

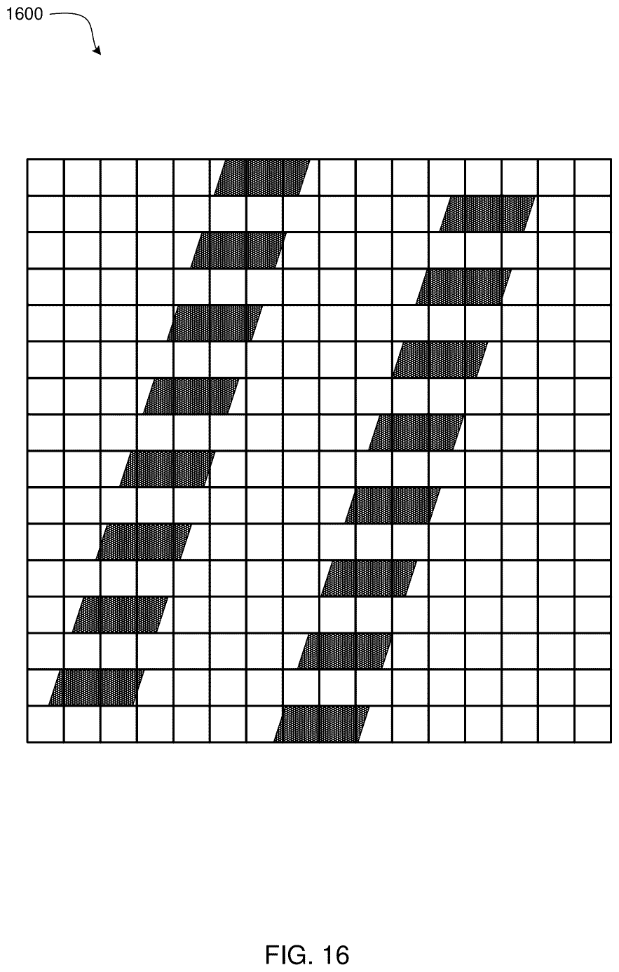

FIG. 16 is a schematic illustration of a representation of an image of a slightly slanted object that is captured with the optical assembly 800 described in connection with FIG. 8. The slightly slanted object is either farther of the convergence plane or closer to the lens. The right and left images are included in the same frame with the odd rows representing the right (or left) aperture and the even rows representing the left (or right) aperture, the shift between the images being the parallax.

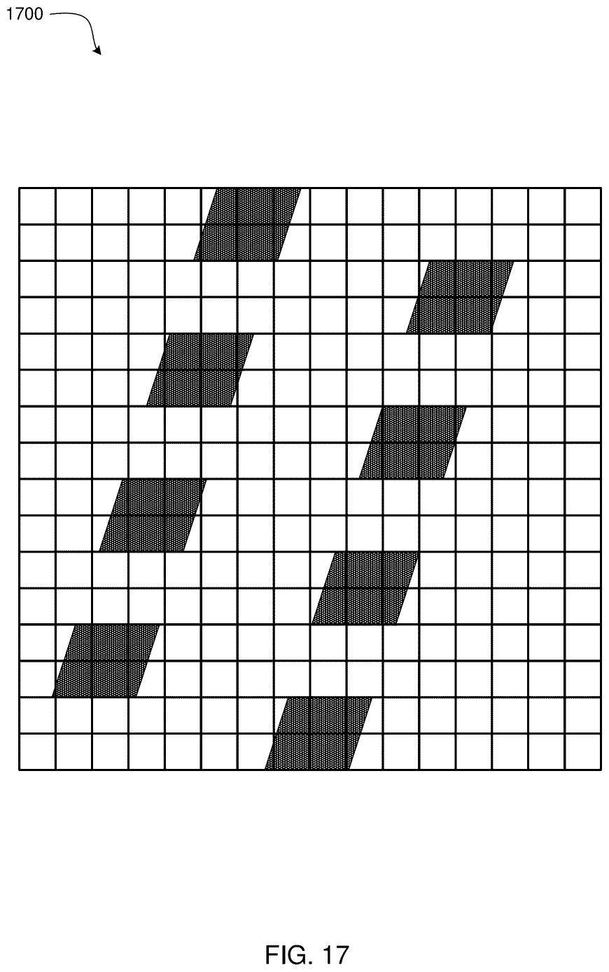

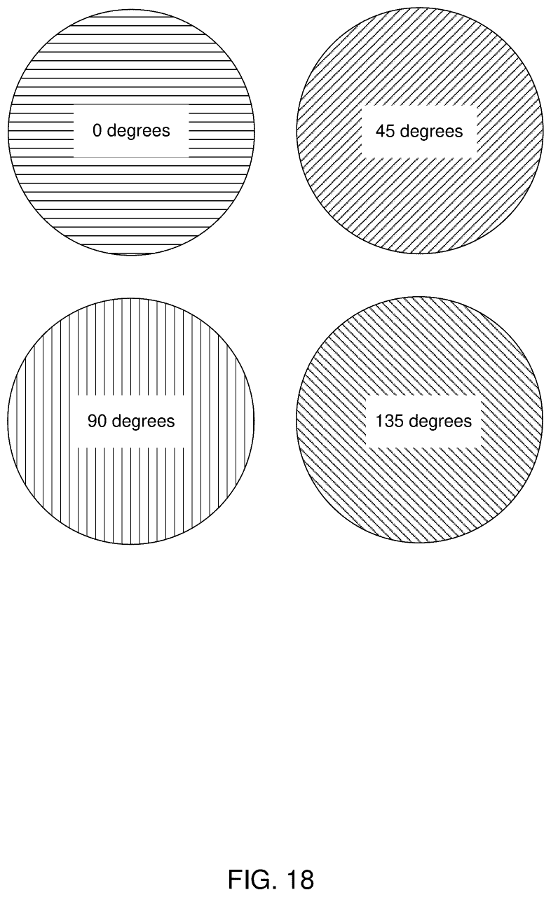

FIG. 17 is a schematic illustration of a representation of an image of a slightly slanted object that is captured with the optical assembly 900 described in connection with FIG. 9.

FIG. 18 is a schematic illustration depicting four exemplary linear polarization filters. The exemplary polarization filters may be implemented in any of the optical assemblies discussed in connection with any of FIGS. 8-15. The exemplary linear polarization filters include a zero-degree filter, 45-degree filter, 90-degree filter, and 135-degree filter.

If an optical assembly includes a P1 filter and a P2 filter that are orthogonal relative to one another, then the P1 filter could include the zero-degree filter and the P2 filter could include the 90-degree filter, or vice versa; alternatively, the P1 filter could include the 45-degree filter and the P1 filter could include the 135-degree filter, or vice versa. The P1 and P2 filters could include any alternative filters that are orthogonal relative to one another such as, for example: 5 degrees and 95 degrees; 10 degrees and 100 degrees, 15 degrees and 105 degrees, and so forth. It should be appreciated that the type or linear polarization filter is immaterial, and that orthogonal filters must only be orthogonal relative to one another.

### EXAMPLES

The following examples pertain to preferred features of further embodiments:

Example 1 is a system for three-dimensional visualization based upon data output by a single image sensor and a single lens assembly. The system includes an aperture stop comprising: a first aperture comprising a first aperture filter, wherein the first aperture filter is a first channel filter; and a second aperture comprising a second aperture filter, wherein the second aperture filter is a second channel filter. The system includes an image sensor comprising a pixel array comprising a plurality of pixels and a plurality of pixel filters, wherein the plurality of pixel filters forms a filter array comprising: a first plurality of pixel filters comprising the first channel filter; and a second plurality of pixel filters comprising the second channel filter.

Example 2 is a system as in Example 1, wherein each of the first channel filter and the second channel filter is a linear polarization filter; wherein the first channel filter transmits only electromagnetic radiation comprising a first polarization; wherein the second channel filter transmits only electromagnetic radiation comprising a second polarization; an wherein the first polarization is orthogonal to the second polarization, within a tolerance threshold of ten percent.

Example 3 is a system as in any of Examples 1-2, wherein each of the first channel filter and the second channel filter is a circular polarization filter.

Example 4 is a system as in any of Examples 1-3, wherein each of the first aperture and the first plurality of pixel filters transmit only electromagnetic radiation comprising a first polarization; wherein each of the second aperture and the second plurality of pixel filters transmit only electromagnetic radiation comprising a second polarization; and wherein the first polarization is orthogonal to the second polarization within a tolerance threshold of ten percent.

Example 5 is a system as in any of Examples 1-4, wherein the filter array of the image sensor comprises a row-based filter array such that: each row of pixels within the pixel array comprises a same type of channel filter across an entirety of the row of pixels; and the type of channel filter alternates every quantity “x” of pixel rows.

Example 6 is a system as in any of Examples 1-5, wherein the filter array of the image sensor comprises a column-based filter array such that: each column of pixels within the pixel array comprises a same type of channel filter down an entirety of the column of pixels; and the type of channel filter alternates every quantity “x” of pixel columns.

Example 7 is a system as in any of Examples 1-6, wherein the filter array further comprises a color filter array comprising a plurality of repeating pixel blocks.

Example 8 is a system as in any of Examples 1-7, wherein the filter array of the image sensor comprises a row-based channel filter array on a per-pixel block basis; wherein each row of pixels within the pixel array comprises a same type of channel filter across an entirety of the row of pixels; wherein the type of channel filter alternates every quantity “x” of pixel rows; and wherein the quantity “x” is equal to a height of the plurality of repeating pixel blocks of the color filter array such that each pixel within a single pixel block has a same type of channel filter.

Example 9 is a system as in any of Examples 1-8, wherein the filter array of the image sensor comprises a column-based channel filter array on a per-pixel block basis; wherein each column of pixels within the pixel array comprises a same type of channel filter across an entirety of the column of pixels; wherein the type of channel filter alternates every quantity “x” of pixel columns; and wherein the quantity “x” is equal to a width of the plurality of repeating pixel blocks of the color filter array such that each pixel within a single pixel block has a same type of channel filter.

Example 10 is a system as in any of Examples 1-9, wherein the color filter array is a Bayer pattern color filter array comprising a plurality of 2×2 repeating pixel blocks, wherein each of the plurality of 2×2 repeating pixel blocks comprises one red filter, two green filters, and one blue filter.

Example 11 is a system as in any of Examples 1-10, wherein the filter array further comprises: a third plurality of pixel filters comprising a first channel filter; and a fourth plurality of pixel filters comprising a fourth channel filter.

Example 12 is a system as in any of Examples 1-11, wherein the first channel filter is a linear polarization filter that transmits only electromagnetic radiation comprising a first polarization; wherein the second channel filter is a linear polarization filter that transmits only electromagnetic radiation comprising a second polarization; wherein the third channel filter is a linear polarization filter that transmits only electromagnetic radiation comprising a third polarization; and wherein the fourth channel filter is a linear polarization filter that transmits only electromagnetic radiation comprising a fourth polarization.

Example 13 is a system as in any of Examples 1-12, wherein the first polarization is orthogonal to the second polarization within a tolerance threshold of ten percent; wherein the third polarization is orthogonal to the fourth polarization within a tolerance threshold of ten percent; wherein the third polarization is plus-or-minus forty-five degrees offset relative to the first polarization or the second polarization within a tolerance threshold of ten percent; and wherein the fourth polarization is plus-or-minus forty-five degrees offset relative to the first polarization or the second polarization within a tolerance threshold of ten percent.

Example 14 is a system as in any of Examples 1-13, wherein a first plurality of pixels comprising the first plurality of pixel filters is irradiated by substantially one-hundred percent of electromagnetic radiation transmitted by the first aperture filter; wherein a second plurality of pixels comprising the second plurality of pixel filters is irradiated by substantially zero percent of electromagnetic radiation transmitted by the first aperture filter; wherein a third plurality of pixels comprising the third plurality of pixel filters is irradiating by substantially fifty percent of electromagnetic radiation transmitted by the first aperture filter; wherein the third plurality of pixels comprising the third plurality of pixel filters is irradiating by substantially fifty percent of electromagnetic radiation transmitted by the second aperture filter; wherein a fourth plurality of pixels comprising the fourth plurality of pixel filters is irradiating by substantially fifty percent of electromagnetic radiation transmitted by the first aperture filter; wherein the fourth plurality of pixels comprising the fourth plurality of pixel filters is irradiating by substantially fifty percent of electromagnetic radiation transmitted by the second aperture filter.

Example 15 is a system as in any of Examples 1-14, wherein the image sensor outputs an image frame comprising: a first plurality of pixel accumulation data output by the first plurality of pixels; a second plurality of pixel accumulation data output by the second plurality of pixels; a third plurality of pixel accumulation data output by the third plurality of pixels; and a fourth plurality of pixel accumulation data output by the fourth plurality pixels; wherein the first plurality of pixel accumulation data is processed as first image channel data and the second plurality of pixel accumulation data is processed as second image channel data to generate a three-dimensional rendering of a scene; and wherein the third plurality of pixel accumulation data and the fourth plurality of pixel accumulation data are combined to generate a two-dimensional rendering of the scene.

Example 16 is a system as in any of Examples 1-15, wherein the three-dimensional rendering of the scene and the two-dimensional rendering of the scene are processed based upon a single image frame.

Example 17 is a system as in any of Examples 1-16, wherein a center of the first aperture is separated from a center of the second aperture by an inter-pupil distance, and wherein the inter-pupil distance is utilized to calculate three-dimensional visualization data based upon a single image frame output by the image sensor.

Example 18 is a system as in any of Examples 1-17, further comprising a lens, wherein the aperture stop is located distal to the lens such that electromagnetic radiation passes through the lens only after first passing through one of the first aperture or the second aperture.

Example 19 is a system as in any of Examples 1-18, wherein the image sensor outputs a single image frame comprising first image channel data and second image channel data; wherein the first image channel data and the second image channel data is provided to an image signal processor to calculate a three-dimensional visualization rendering based upon the single image frame.

Example 20 is a system as in any of Examples 1-19, wherein each of the first aperture and the second aperture comprises one or more of a circular geometry, an elliptical geometry, or a crescent geometry.

It will be appreciated that various features disclosed herein provide significant advantages and advancements in the art. The following claims are exemplary of some of those features.

In the foregoing Detailed Description of the Disclosure, various features of the disclosure are grouped together in a single embodiment for the purpose of streamlining the disclosure. This method of disclosure is not to be interpreted as reflecting an intention that the claimed disclosure requires more features than are expressly recited in each claim. Rather, inventive aspects lie in less than all features of a single foregoing disclosed embodiment.

It is to be understood that any features of the above-described arrangements, examples, and embodiments may be combined in a single embodiment comprising a combination of features taken from any of the disclosed arrangements, examples, and embodiments.

It is to be understood that the above-described arrangements are only illustrative of the application of the principles of the disclosure. Numerous modifications and alternative arrangements may be devised by those skilled in the art without departing from the spirit and scope of the disclosure and the appended claims are intended to cover such modifications and arrangements.

Thus, while the disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

The foregoing description has been presented for the purposes of illustration and description. It is not intended to be exhaustive or to limit the disclosure to the precise form disclosed. Many modifications and variations are possible in light of the above teaching. Further, it should be noted that any or all the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

What is claimed is:

1. A system for three-dimensional visualization, the system comprising:
an aperture stop comprising:
a first aperture comprising a first aperture filter, wherein the first aperture filter is a first channel filter; and
a second aperture comprising a second aperture filter, wherein the second aperture filter is a second channel filter; and
an image sensor comprising a pixel array comprising a plurality of pixels and a plurality of pixel filters, wherein the plurality of pixel filters forms a filter array comprising:
a first plurality of pixel filters comprising the first channel filter; and
a second plurality of pixel filters comprising the second channel filter.

2. The system of claim 1, wherein each of the first channel filter and the second channel filter is a linear polarization filter;
wherein the first channel filter transmits only electromagnetic radiation comprising a first polarization;
wherein the second channel filter transmits only electromagnetic radiation comprising a second polarization; and
wherein the first polarization is orthogonal to the second polarization, within a tolerance threshold of ten percent.

3. The system of claim 1, wherein each of the first channel filter and the second channel filter is a circular polarization filter.

4. The system of claim 1, wherein each of the first aperture and the first plurality of pixel filters transmit only electromagnetic radiation comprising a first polarization;
wherein each of the second aperture and the second plurality of pixel filters transmit only electromagnetic radiation comprising a second polarization; and
wherein the first polarization is orthogonal to the second polarization within a tolerance threshold of ten percent.

5. The system of claim 1, wherein the filter array of the image sensor comprises a row-based filter array such that:
each row of pixels within the pixel array comprises a same type of channel filter across an entirety of the row of pixels; and
the type of channel filter alternates every quantity “x” of pixel rows.

6. The system of claim 1, wherein the filter array of the image sensor comprises a column-based filter array such that:
each column of pixels within the pixel array comprises a same type of channel filter down an entirety of the column of pixels; and
the type of channel filter alternates every quantity “x” of pixel columns.

7. The system of claim 1, wherein the filter array further comprises a color filter array comprising a plurality of repeating pixel blocks.

8. The system of claim 7, wherein the filter array of the image sensor comprises a row-based channel filter array on a per-pixel block basis;
wherein each row of pixels within the pixel array comprises a same type of channel filter across an entirety of the row of pixels;
wherein the type of channel filter alternates every quantity “x” of pixel rows; and
wherein the quantity “x” is equal to a height of the plurality of repeating pixel blocks of the color filter array such that each pixel within a single pixel block has a same type of channel filter.

9. The system of claim 7, wherein the filter array of the image sensor comprises a column-based channel filter array on a per-pixel block basis;
wherein each column of pixels within the pixel array comprises a same type of channel filter across an entirety of the column of pixels;
wherein the type of channel filter alternates every quantity “x” of pixel columns; and
wherein the quantity “x” is equal to a width of the plurality of repeating pixel blocks of the color filter array such that each pixel within a single pixel block has a same type of channel filter.

10. The system of claim 7, wherein the color filter array is a Bayer pattern color filter array comprising a plurality of 2×2 repeating pixel blocks, wherein each of the plurality of 2×2 repeating pixel blocks comprises one red filter, two green filters, and one blue filter.

11. The system of claim 1, wherein the filter array further comprises:
a third plurality of pixel filters comprising a first channel filter; and
a fourth plurality of pixel filters comprising a fourth channel filter.

12. The system of claim 11, wherein the first channel filter is a linear polarization filter that transmits only electromagnetic radiation comprising a first polarization;
wherein the second channel filter is a linear polarization filter that transmits only electromagnetic radiation comprising a second polarization;
wherein the third channel filter is a linear polarization filter that transmits only electromagnetic radiation comprising a third polarization; and
wherein the fourth channel filter is a linear polarization filter that transmits only electromagnetic radiation comprising a fourth polarization.

13. The system of claim 12, wherein the first polarization is orthogonal to the second polarization within a tolerance threshold of ten percent;
wherein the third polarization is orthogonal to the fourth polarization within a tolerance threshold of ten percent;
wherein the third polarization is plus-or-minus forty-five degrees offset relative to the first polarization or the second polarization within a tolerance threshold of ten percent; and
wherein the fourth polarization is plus-or-minus forty-five degrees offset relative to the first polarization or the second polarization within a tolerance threshold of ten percent.

14. The system of claim 13, wherein a first plurality of pixels comprising the first plurality of pixel filters is irradiated by substantially one-hundred percent of electromagnetic radiation transmitted by the first aperture filter;
wherein a second plurality of pixels comprising the second plurality of pixel filters is irradiated by substantially zero percent of electromagnetic radiation transmitted by the first aperture filter;
wherein a third plurality of pixels comprising the third plurality of pixel filters is irradiating by substantially fifty percent of electromagnetic radiation transmitted by the first aperture filter;
wherein the third plurality of pixels comprising the third plurality of pixel filters is irradiating by substantially fifty percent of electromagnetic radiation transmitted by the second aperture filter;
wherein a fourth plurality of pixels comprising the fourth plurality of pixel filters is irradiating by substantially fifty percent of electromagnetic radiation transmitted by the first aperture filter;
wherein the fourth plurality of pixels comprising the fourth plurality of pixel filters is irradiating by substantially fifty percent of electromagnetic radiation transmitted by the second aperture filter.

15. The system of claim 14, wherein the image sensor outputs an image frame comprising:
a first plurality of pixel accumulation data output by the first plurality of pixels;
a second plurality of pixel accumulation data output by the second plurality of pixels;
a third plurality of pixel accumulation data output by the third plurality of pixels; and
a fourth plurality of pixel accumulation data output by the fourth plurality pixels;
wherein the first plurality of pixel accumulation data is processed as first image channel data and the second plurality of pixel accumulation data is processed as second image channel data to generate a three-dimensional rendering of a scene; and
wherein the third plurality of pixel accumulation data and the fourth plurality of pixel accumulation data are combined to generate a two-dimensional rendering of the scene.

16. The system of claim 15, wherein the three-dimensional rendering of the scene and the two-dimensional rendering of the scene are processed based upon a single image frame.

17. The system of claim 1, wherein a center of the first aperture is separated from a center of the second aperture by an inter-pupil distance, and wherein the inter-pupil distance is utilized to calculate three-dimensional visualization data based upon a single image frame output by the image sensor.

18. The system of claim 1, further comprising a lens, wherein the aperture stop is located distal to the lens such that electromagnetic radiation passes through the lens only after first passing through one of the first aperture or the second aperture.

19. The system of claim 1, wherein the image sensor outputs a single image frame comprising first image channel data and second image channel data;
wherein the first image channel data and the second image channel data is provided to an image signal processor to calculate a three-dimensional visualization rendering based upon the single image frame.

20. The system of claim 1, wherein each of the first aperture and the second aperture comprises one or more of a circular geometry, an elliptical geometry, or a crescent geometry.
